(19) United States
(12) Patent Application Publication
(10) Pub. No.: US 2026/0100455 A1
(43) Pub. Date: Apr. 9, 2026

(54) SECONDARY BATTERY AND BATTERY PACK INCLUDING THE SECONDARY BATTERY

(71) Applicant: SAMSUNG SDI CO., LTD., Yongin-si (KR)

(72) Inventor: Il Oh SON, Yongin-si (KR)

(21) Appl. No.: 19/281,935

(22) Filed: Jul. 28, 2025

(30) Foreign Application Priority Data
Oct. 4, 2024 (KR) 10-2024-0134623

(51) Int. Cl. H01M 50/147; H01M 50/204; H01M 50/533

(52) U.S. Cl. CPC H01M 50/147; H01M 50/204; H01M 50/533

(57) ABSTRACT

A secondary battery includes a case having an opening formed therein, an electrode assembly accommodated in the case, a cap assembly closing the opening, and an electrode tab that is electrically connected to the electrode assembly and the cap assembly. A thickness of the electrode tab decreases from an end portion of the electrode tab toward a central portion of the electrode assembly in a height direction of the electrode assembly.

### CROSS-REFERENCE TO RELATED APPLICATION

The present application claims priority to and the benefit of Korean Patent Application No. 10-2024-0134623, filed on October 4, 2024, in the Korean Intellectual Property Office, the entire disclosure of which is incorporated herein by reference.

### BACKGROUND

### Field of the Invention

The present disclosure relates to a secondary battery and a battery pack including the secondary battery.

### Discussion of Related Art

Unlike primary batteries that cannot be recharged, secondary batteries are capable of being recharged and discharged. Low-capacity secondary batteries are used in small portable electronic devices such as smartphones, feature phones, notebook computers, digital cameras, and camcorders. Large-capacity secondary batteries are widely used as power sources for driving motors of hybrid vehicles, electric vehicles, and the like and for power storage. A secondary battery includes an electrode assembly including a positive electrode and a negative electrode, a case for accommodating the electrode assembly, an electrode tab connected to the electrode assembly, and the like.

An electrode tab and an electrode assembly may be electrically connected, and, in some cases, the electrode assembly may be deformed due to a thickness of the electrode tab. When the electrode assembly is deformed, cracks may occur in the electrode assembly, thereby increasing the possibility of a short occurring in the secondary battery. Therefore, a secondary battery in which deformation of an electrode assembly due to an electrode tab is minimized is desirable.

The above information disclosed in this background section is provided for enhancement of understanding of the background of the present disclosure. It may contain information that does not constitute related (or prior) art.

### SUMMARY OF THE DISCLOSURE

The present disclosure is directed to providing a secondary battery including an electrode tab that allows deformation of an electrode assembly to be minimized and a battery pack including the secondary battery.

In addition, the present disclosure is directed to providing a secondary battery with improved durability and safety and a battery pack including the secondary battery.

These and other aspects and features of the present disclosure will be described in or will be apparent from the following description of some embodiments of the present disclosure.

In accordance with one aspect of the present disclosure, there is a provided a secondary battery including a case including an opening formed therein, an electrode assembly accommodated in the case, a cap assembly closing the opening, and an electrode tab that is electrically connected to the electrode assembly and the cap assembly, with a thickness of the electrode tab decreasing from an end portion of the electrode tab toward a central portion of the electrode assembly in a height direction of the electrode assembly.

The cap assembly may include a upper cap disposed at the opening, a lower cap disposed to face the upper cap and connected to the electrode assembly, and a bent plate disposed between the upper cap and the lower cap.

A cross section of the electrode tab that is perpendicular to a longitudinal direction of the electrode tab may be a quadrangular shape.

A cross section of the electrode tab that is perpendicular to a longitudinal direction of the electrode tab may be a closed curved shape.

A width of the electrode tab may be constant from the end portion toward the central portion of the electrode assembly in the height direction of the electrode assembly.

A width of the electrode tab may increase from the end portion toward the central portion of the electrode assembly in the height direction of the electrode assembly.

The electrode tab may be positioned at a center portion of the electrode assembly in a radial direction of the electrode assembly.

The electrode tab may be positioned at an outer portion of the electrode assembly in a radial direction of the electrode assembly.

The electrode tab may be positioned between a center portion and an outer portion of the electrode assembly in a radial direction of the electrode assembly.

The electrode tab may include a first electrode tab electrically connected to the cap assembly and a second electrode tab electrically connected to the case.

The first electrode tab and the second electrode tab may be spaced apart from each other in a radial direction of the electrode assembly.

The first electrode tab and the second electrode tab may be overlap in a radial direction of the electrode assembly.

The first electrode tab and the second electrode tab may be spaced apart from each other in the height direction of the electrode assembly.

The first electrode tab and the second electrode tab may be overlap in the height direction of the electrode assembly.

In accordance with another aspect of the present invention, there is provided a battery pack including a housing and a plurality of secondary batteries disposed in the housing, wherein each of the secondary battery includes a case having an opening formed therein, an electrode assembly accommodated in the case, a cap assembly closing the opening, and an electrode tab that is electrically connected to the electrode assembly and the cap assembly, with a thickness of the electrode tab decreasing from an end portion of the electrode tab toward a central portion of the electrode assembly in a height direction of the electrode assembly.

A cross section of the electrode tab that is perpendicular to a longitudinal direction of the electrode tab may be a quadrangular shape.

A cross section of the electrode tab that is perpendicular to a longitudinal direction of the electrode tab may be a closed curved shape.

A width of the electrode tab may be constant from the end portion of the electrode tab toward the central portion of the electrode assembly in the height direction of the electrode assembly.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure is not limited to the embodiments depicted in the drawings.

FIG. 1 is a perspective view of a secondary battery according to one embodiment of the present disclosure;

FIG. 2 is a cross-sectional view of the secondary battery according to one embodiment of the present disclosure;

FIG. 3 is a side view of an electrode tab according to one embodiment of the present invention;

FIG. 4 is a plan view of a first example of the electrode tab according to the present disclosure;

FIG. 5 is a plan view of a second example of the electrode tab according to the present disclosure;

FIG. 6 is a top view of the first example of the electrode tab according to the present disclosure;

FIG. 7 is a top view of the second example of the electrode tab according to the present disclosure;

FIG. 8 is a front perspective view of a first example in which an electrode tab is disposed in a secondary battery according to the present disclosure;

FIG. 9 is a side perspective view of the first example in which the electrode tab is disposed in the secondary battery according to the present disclosure;

FIG. 10 is a plan view of the first example in which the electrode tab is disposed in the secondary battery according to the present disclosure;

FIG. 11 is a cross-sectional view of the first example in which the electrode tab is disposed in the secondary battery according to the present disclosure;

FIG. 12 is a plan view of a second example in which an electrode tab is disposed in a secondary battery according to the present disclosure;

FIG. 13 is a cross-sectional view of the second example in which the electrode tab is disposed in the secondary battery according to the present disclosure;

FIG. 14 is a plan view of a third example in which an electrode tab is disposed in a secondary battery according to the present disclosure;

FIG. 15 is a cross-sectional view of the third example in which the electrode tab is disposed in the secondary battery according to the present disclosure;

FIG. 16 is a plan view of a fourth example in which an electrode tab is disposed in a secondary battery according to the present disclosure;

FIG. 17 is a cross-sectional view of a fifth example in which an electrode tab is disposed in a secondary battery according to the present disclosure; and

FIG. 18 is an exploded perspective view of a battery pack according to one embodiment of the present disclosure.

### DETAILED DESCRIPTION OF EXEMPLARY EMBODIMENTS

Some embodiments of the present disclosure will be described with reference to the accompanying drawings. The terms or words used in this specification and claims should not be construed as being limited to the usual or dictionary meaning and should be interpreted consistent with the technical idea of the present disclosure and based on the principle that the inventor can be his/her own lexicographer.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure. Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Numerical ranges disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being disposed (or located or positioned) on the “above (or below)” or “on (or under)” a component, it may mean that the element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

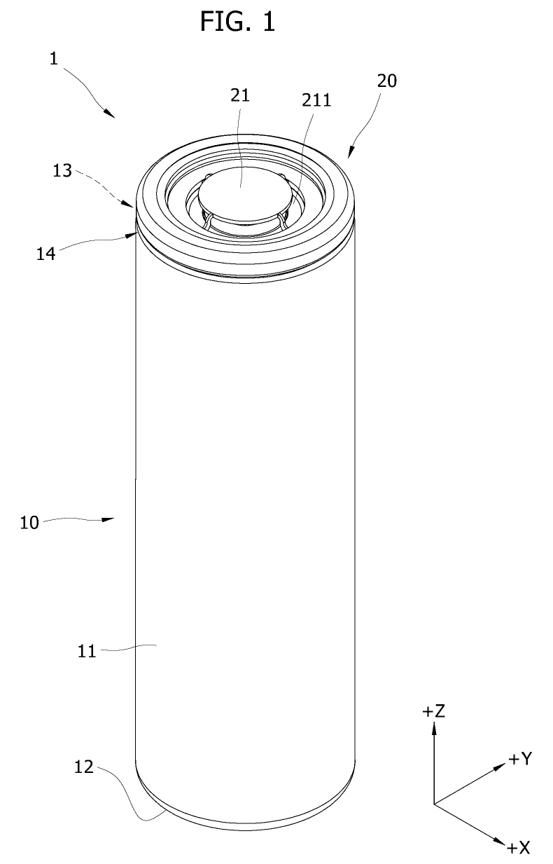

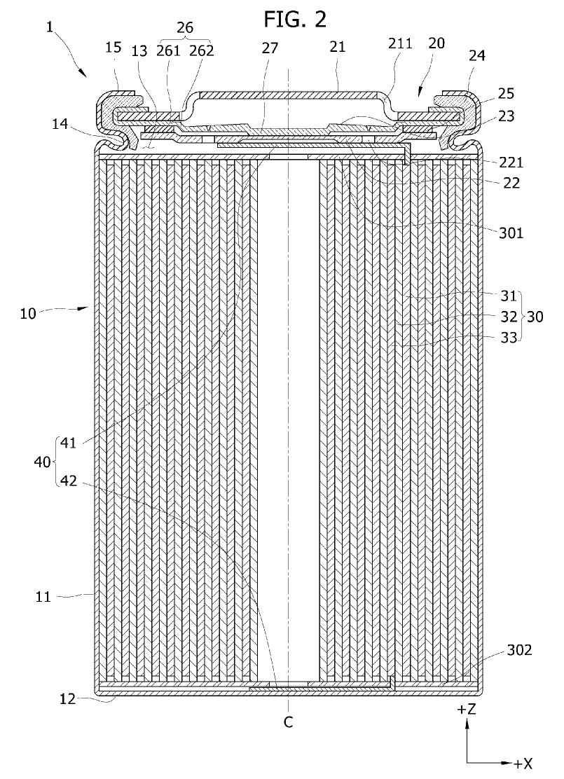

FIG. 1 is a perspective view illustrating a secondary battery according to one embodiment of the present disclosure, and FIG. 2 is a cross-sectional view illustrating the secondary battery according to one embodiment of the present disclosure.

Referring to FIGS. 1 and 2, a secondary battery 1 according to the present embodiment may include a case 10, a cap assembly 20, an electrode assembly 30, and an electrode tab 40.

Hereinafter, a cylindrical lithium-ion secondary battery will be described as an example of the secondary battery 1. However, the present disclosure is not limited to such a battery, and the secondary battery 1 may be, for example, a lithium polymer battery or an angular battery.

The case 10 may form an exterior of the secondary battery 1. The case 10 may be provided to allow a current to flow through it. For example, the case 10 may include one or more materials such as steel, stainless steel, aluminum, and an aluminum alloy. The case 10 may serve to protect the electrode assembly 30 from an external impact and serve a heat dissipation function of dissipating heat according to charging and discharging operations of the electrode assembly 30.

The case 10 according to the present embodiment may include a cylindrical sidewall portion 11 in which a central axis C of the case 10 is formed in a central portion. The central axis C of the case 10, which will be described below, may be a central axis of the sidewall portion 11. Both end portions of the sidewall portion 11 that are perpendicular to the central axis C of the case 10 may be open. According to one embodiment, an upper side (for example, in a +Z-axis direction) of the sidewall portion 11 may be open.

The case 10 may further include a bottom portion 12 that closes a lower end portion (for example, in a −Z-axis direction) of the sidewall portion 11. The bottom portion 12 according to the present embodiment may be formed to have substantially a disk shape. The bottom portion 12 may be disposed perpendicular to the central axis C of the case 10. A perimeter surface of the bottom portion 12 may be coupled to the lower end portion of the sidewall portion 11. The bottom portion 12 may be integrally molded with the sidewall portion 11 through a drawing process or the like. Alternatively, the bottom portion 12 may be manufactured separately from the sidewall portion 11 and then may be coupled to the sidewall portion 11 through a welding process or the like.

The case 10 may further include an opening 13 at an upper end portion (for example, in the +Z-axis direction) of the sidewall portion 11. The opening 13 may provide a passage through which the electrode assembly 30 (described below) is inserted into the case 10 in an upper end region of the case 10 and provides a space in which the cap assembly 20 (described below) may be installed. The opening 13 according to the present embodiment may be an empty space surrounded by a region of the upper end portion of the sidewall portion 11 located at the side that is opposite to the bottom portion 12.

The electrode assembly 30 may serve as a unit structure that performs power charging and discharging operations in the secondary battery 1. The electrode assembly 30 may include a first electrode plate 31, a second electrode plate 32, and a separation membrane 33 disposed between the first electrode plate 31 and the second electrode plate 32.

The electrode assembly 30 may be disposed in the case 10. The electrode assembly 30 may be inserted into the case 10 through the opening 13 of the case 10.

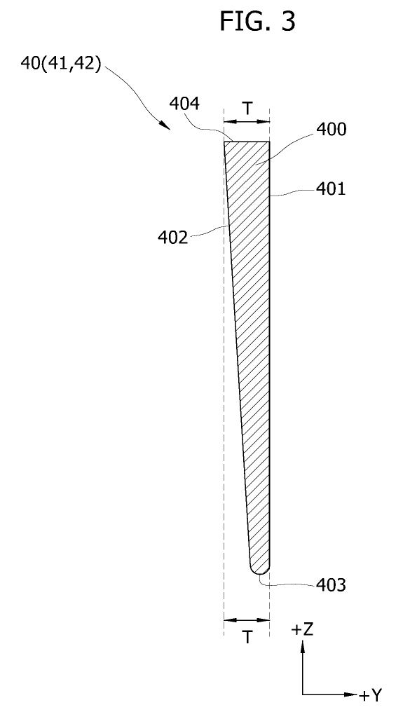

The electrode tab 40 may electrically connect the electrode assembly 30 to the case 10 and the cap assembly 20. The electrode tab 40 may include a first electrode tab 41 and a second electrode tab 42. The electrode tab 40 will be described below with reference to FIGS. 3 to 7.

The electrode assembly 30 may have a shape that is wound around a winding axis. More specifically, the electrode assembly 30 may have a shape in which the first electrode plate 31, the separation membrane 33, and the second electrode plate 32 are stacked and wound around the winding axis in a clockwise or counter-clockwise direction. Thus, the electrode assembly 30 may have substantially a jelly roll shape. But the cross-sectional shape of the electrode assembly 30 may be changed to any of various shapes such as an elliptical shape and a polygonal shape rather than a circular shape. In this embodiment, the winding axis may be a straight line passing through a central portion of the electrode assembly 30. The winding axis of the electrode assembly 30 may be coaxially disposed with the central axis C of the case 10.

The first electrode plate 31 may be a positive electrode of the electrode assembly 30. The first electrode plate 31 may be formed in the shape of a foil including a metal material such as aluminum or an aluminum alloy. The type, size, and shape of the first electrode plate 31 are not limited as long as a metal material has conductivity and does not cause a chemical change in the secondary battery.

A first active material layer may be applied on at least a portion of the first electrode plate 31. The first active material layer may be applied on each of both surfaces of the first electrode plate 31. Alternatively, the first active material layer may be applied on only one surface of the first electrode plate 31.

As the first electrode plate 31 serves as the positive electrode, the first active material layer may include a positive active material. The positive active material may be a reversible intercalation and deintercalation compound (lithiated intercalation compound) for lithium. More specifically, the positive active material may be one or more compound oxides of a metal selected from cobalt, manganese, nickel, iron, and a combination thereof and lithium may be used as the positive active material. As specific examples, the positive active material may include any of a lithium-iron-phosphorus oxide (LiFePO₄, LFP), a lithium-manganese-iron-phosphorus oxide (LiMnFePO₄, LMFP), and a lithium-nickel-cobalt-manganese oxide (LiNiₓCo_{y}Mn_{z}O₂, NCM). In these formulas, 0<x<1, 0<y<1, 0<z<1, and x+y+z=1. The positive active material may include only any one of the lithium-iron-phosphorus oxide (LiFePO₄, LFP), the lithium-manganese-iron-phosphorus oxide (LiMnFePO₄, LMFP), and the lithium-nickel-cobalt-manganese oxide (LiNiₓCo_{y}Mn_{z}O₂, LNCM), or may include any two or all of the lithium-iron-phosphorus oxide (LiFePO₄, LFP), the lithium-manganese-iron-phosphorus oxide (LiMnFePO₄, LMFP), and the lithium-nickel-cobalt-manganese oxide (LiNiₓCo_{y}Mn_{z}O₂, LNCM).

The first active material layer may further include a positive conductive material. The positive conductive material provides conductivity to the first active material layer, and any material may be used as the positive conductive material as long as the material is electrically conductive and does not chemically change the first active material layer. Examples of the positive conductive material include a carbon-based material such as natural graphite, artificial graphite, carbon black, acetylene black, Ketjenblack, carbon fibers, carbon nanofibers, and carbon nanotubes, a metal-based material in the form of a metal powder or metal fibers containing copper, nickel, aluminum, silver, and the like, a conductive polymer such as a polyphenylene derivative, or a mixture of such materials.

The first active material layer may further include a positive electrode binder. The positive electrode binder serves to attach particles constituting the positive active material and attach the positive active material to the first electrode plate 31. A non-aqueous binder, an aqueous binder, a dry binder, or a combination thereof may be used as an example of the positive electrode binder.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, a polyvinyl alcohol, and combinations thereof.

When the aqueous binder is used as the positive electrode binder, the first active material layer may further include a cellulose compound that provides viscosity. One or more of carboxymethyl cellulose, hydroxypropyl methyl cellulose, methyl cellulose, and an alkaline metal salt thereof may be mixed and used as the cellulose compound. Na, K, or Li may be used as an alkaline metal.

The dry binder is a fibrous polymer material, and may be, for example, polytetrafluoroethylene, polyvinylidene fluoride, a polyvinylidene fluoride-hexafluoropropylene copolymer, polyethylene oxide, or a combination thereof.

The first electrode plate 31 may be electrically connected to the cap assembly 20, which will be described below. As the first electrode plate 31 is the positive electrode of the electrode assembly 30, the cap assembly 20 may be a positive terminal of the secondary battery 1. As an example, the first electrode plate 31 may be electrically connected to the cap assembly 20 through the first electrode tab 41. The first electrode tab 41 according to the present embodiment may include a conductive metal material such as copper, a copper alloy, nickel, or a nickel alloy. The first electrode tab 41 may be disposed on (for example, in a +Z direction from) the electrode assembly 30, and the end portions of the first electrode tab 41 may be connected to the first electrode plate 31 and the cap assembly 20. One end portion of the first electrode tab 41 may be directly connected to the first electrode plate 31 or indirectly connected to the first electrode plate 31 through a separate current collection plate (not shown) connected to the first electrode plate 31.

The second electrode plate 32 be a negative electrode of the electrode assembly 30. The second electrode plate 32 may be formed in the shape of a foil including a metal material such as copper, a copper alloy, nickel, or a nickel alloy. The second electrode plate 32 may be spaced a predetermined distance from the first electrode plate 31 and face the first electrode plate 31.

The type, size, and shape of the second electrode plate 32 are not limited as long as the metal material has electrical conductivity and does not cause a chemical change in the secondary battery.

A second active material layer may be applied on at least a portion of the second electrode plate 32. The second active material layer may be applied on both surfaces of the second electrode plate 32. Alternatively, the second active material layer may be applied on only one surface of the second electrode plate 32.

As the second electrode plate 32 is the negative electrode, the second active material layer may include a negative active material. The negative active material may include a material into which lithium-ions may be reversibly intercalated and/or from which lithium-ions may be reversibly deintercalated, a lithium metal, a lithium metal alloy, a material which may be doped in and undoped from lithium, or transition metal oxide.

The material into which lithium-ions may be reversibly intercalated and/or from which lithium-ions may be reversibly deintercalated may include a carbon-based negative active material, such as, crystalline carbon, amorphous carbon, or a combination thereof. Examples of the crystalline carbon are graphite such as natural graphite or artificial graphite in amorphous, flake, spherical, or fibrous form, and an example of the amorphous carbon may be soft or hard carbon, mesophase pitch carbide, fired coke, or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the lithium metal alloy.

A Si-based negative active material or a Sn-based negative active material may be used as the material which may be doped in and undoped from lithium. The Si-based negative active material may be silicon, a silicon-carbon composite, SiOₓ (x=1 or 2), a Si-Q alloy, or a combination thereof. In the Si-Q formula, Q is selected from alkaline metals, alkaline earth metals, a Group 13 element, a Group 14 element (excluding Si), a Group 15 element, a Group 16 element, a transition metal, a rare earth element, and a combination thereof. The Sn-based negative active material may be Sn, SnO₂, a Sn-based alloy, or a combination thereof.

The silicon-carbon composite may be a composite of silicon and amorphous carbon. According to one embodiment, the silicon-carbon composite may have a form including silicon particles and amorphous carbon applied on surfaces of the silicon particles. For example, the silicon-carbon composite may include secondary particles (core) in which silicon primary particles are assembled and amorphous carbon coated layers (shell) located on surfaces of the secondary particles. The amorphous carbon may also be located between the silicon primary particles so that, for example, the silicon primary particles may be coated with the amorphous carbon. The secondary particles may be dispersed in an amorphous carbon matrix.

The silicon-carbon composite may also further include crystalline carbon. For example, the silicon-carbon composite may include a core including the crystalline carbon and the silicon particles and the amorphous carbon coated layer located on a surface of the core.

The Si-based negative active material or the Sn-based negative active material may be mixed with the carbon-based negative active material and used.

The second active material layer may further include a negative conductive material and a negative electrode binder.

The negative conductive material is used for providing conductivity to the second active material layer, and any material may be used as the negative conductive material as long as the material is electrically conductive and does not cause a chemical change in the second active material layer. An example of the negative conductive material may be a carbon-based material such as natural graphite, artificial graphite, carbon black, acetylene black, Ketjen black, carbon fibers, carbon nanofibers, and carbon nanotubes, a metal-based material in the form of a metal powder or metal fibers containing copper, nickel, aluminum, silver, and the like, a conductive polymer such as a polyphenylene derivative, or a mixture thereof.

The negative electrode binder serves to attach particles constituting the negative active material and attach the negative active material to the second electrode plate 32.

A non-aqueous binder, an aqueous binder, a dry binder, or a combination thereof may be used as the negative electrode binder. The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof. The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, a polyvinyl alcohol, and a combination thereof.

When the aqueous binder is used as the negative electrode binder, the first active material layer may further include a cellulose compound that provides viscosity. One or more of carboxymethyl cellulose, hydroxypropyl methyl cellulose, methyl cellulose, and an alkaline metal salt thereof may be mixed and used as the cellulose compound. Na, K, or Li may be used as an alkaline metal.

The dry binder is a fibrous polymer material, and may be, for example, polytetrafluoroethylene, polyvinylidene fluoride, a polyvinylidene fluoride-hexafluoropropylene copolymer, polyethylene oxide, or a combination thereof.

The second electrode plate 32 may be electrically connected to the case 10. As an example, the second electrode plate 32 may be electrically connected to the case 10 through the second electrode tab 42. As the second electrode plate 32 is the negative electrode of the electrode assembly 30, the case 10 may be a negative terminal of the secondary battery 1. The second electrode tab 42 according to the present embodiment may include a conductive metal material such as copper, a copper alloy, nickel, or a nickel alloy. The second electrode tab 42 may be disposed under the electrode assembly 30, and end portions of the second electrode tab 42 may be connected to the second electrode plate 32 and the bottom portion 12 of the case 10. One end portion of the second electrode tab 42 may be directly connected to the second electrode plate 32 or indirectly connected to the second electrode plate 32 through a separate current collection plate (not shown) connected to the second electrode plate 32.

The separation membrane 33 may be disposed between the first electrode plate 31 and the second electrode plate 32. The separation membrane 33 may serve to allow lithium-ions to move between the first electrode plate 31 and the second electrode plate 32 and prevent a short between the first electrode plate 31 and the second electrode plate 32.

Polyethylene, polypropylene, polyvinylidene fluoride, or a multilayer membrane with two or more layers thereof may be used as the separation membrane 33, and a mixed multilayer membrane such as a two-layer separator with polyethylene/polypropylene, a three-layer separator with polyethylene/polypropylene/polyethylene, and a three-layer separator with polypropylene/polyethylene/polypropylene may be used as the separation membrane 33.

The separation membrane 33 may include a porous substrate and a coated layer that is located on one surface or both surfaces of the porous substrate and includes an organic material, an inorganic material, or a combination thereof. The porous substrate may be selected from polyolefins such as polyethylene and polypropylene, polyesters such as polyethylene terephthalate and polybutylene terephthalate, polyacetal, polyamide, polyimide, polycarbonate, polyetherketone, polyaryl etherketone, polyetherimide, polyamideimide, polybenzimidazole, polyethersulfone, polyphenylene oxide, a cyclic olefin copolymer, polyphenylene sulfide, polyethylene naphthalate, glass fiber, Teflon®, and polytetrafluoroethylene, or a polymer membrane formed of two or more of these copolymers or mixtures.

The organic material may include a polyvinylidene fluoride-based polymer or (meth)acrylic-based polymer. The inorganic material may include inorganic particles selected from Al₂O₃, SiO₂, TiO₂, SnO₂, CeO₂, MgO, NiO, CaO, GaO, ZnO, ZrO₂, Y2O₃, SrTiO₃, BaTiO₃, Mg(OH₂), boehmite and a composition thereof. But the present disclosure is not limited to these examples. The organic material and the inorganic material may be mixed and be formed as one coated layer or may be formed as a first coated layer including the organic material and a second coated layer including the inorganic material, with the first and second coating layers being stacked.

The separation membrane 33 may be provided as a pair of separation membranes 33. The pair of separation membranes 33 may be disposed to face surfaces of the first electrode plate 31 or the second electrode plate 32. The pair of separation membranes 33 may be wound around the winding axis with the first electrode plate 210 and the second electrode plate 220.

A first insulation plate 301 and a second insulation plate 302 may be disposed on both sides of the electrode assembly 30. Each of the first insulation plate 301 and the second insulation plate 302 may include an insulation material such as rubber, polyethylene (PE), polypropylene (PP), or polyethylene terephthalate (PET).

The first insulation plate 301 according to the present embodiment may be formed in substantially a disk shape. The first insulation plate 301 may be disposed between an upper surface of the electrode assembly 30 and the cap assembly 20. Accordingly, the first insulation plate 301 may block the upper surface of the electrode assembly 30 from coming in direct contact with the cap assembly 20 and insulate the electrode assembly 30 from the cap assembly 20. A hole (not shown) through which the first electrode tab 41 may pass may be formed in the first insulation plate 301.

The second insulation plate 302 according to the present embodiment may be formed in substantially a disk shape. The second insulation plate 302 may be disposed between a lower surface of the electrode assembly 30 and the bottom portion 12 of the case 10. Accordingly, the second insulation plate 302 may block the lower surface of the electrode assembly 30 from coming in direct contact with the bottom portion 12 of the case 10 and insulate the electrode assembly 30 from the bottom portion 12 of the case 10. A hole (not shown) through which the second electrode tab 42 may pass may be formed in the second insulation plate 302.

The cap assembly 20 may be coupled to the case 10 and may seal the opening 13 of the case 10.

As an example, the cap assembly 20 may be disposed on the upper end portion of the sidewall portion 11 that is adjacent to the opening 13. A beading part 14 that is recessed toward the central axis C of the case 10 may be formed in the sidewall portion 11. The beading part 14 may be disposed under the cap assembly 20 and may restrict the cap assembly 20 from being moved a predetermined distance or more into the case 10. A crimping part 15, in which the upper end portion of the sidewall portion 11 is bent toward the central axis C of the case 10 may be formed above the beading part 14. The crimping part 15 may be formed above the cap assembly 20 and may prevent the cap assembly 20 from being separated to the outside of the case 10.

A gasket 24 may be disposed between the case 10 and the cap assembly 20. The gasket 24 fixes a location of the cap assembly 20 at the opening 13 using an elastic restoring force of the gasket 24, electrically insulates the case 10 from the cap assembly 20, and blocks moisture or electrolyte from being introduced or discharged through a gap between the case 10 and the cap assembly 20.

The gasket 24 according to the present embodiment may include an insulation material such as rubber, PE, PP, or PET. The gasket 24 may be formed in substantially a ring shape and disposed inside the beading part 14 and/or the crimping part 15. An outer surface of the gasket 24 may be in contact with an inner surface of the beading part 14 and/or the crimping part 15, and an inner surface of the gasket 24 may be in contact with an outer surface of the cap assembly 20.

The cap assembly 20 may be electrically connected to the first electrode plate 31 through the first electrode tab 41. As the first electrode plate 31 is the positive electrode of the electrode assembly 30, the cap assembly 20 be a positive terminal of the secondary battery.

The cap assembly 20 may block electrical connection between the secondary battery 1 and an external device when an internal pressure of the case 10 increases due to an overcurrent or the like. The cap assembly 20 may be broken to allow an inner space of the case 10 to be in fluid communication with outside of the case 10 when the internal pressure of the case 10 increases to a set magnitude or more. Accordingly, the cap assembly 20 may lower a risk of explosion of the secondary battery 1 when an overcurrent is generated.

The cap assembly 20 may include an upper cap 21, a lower cap 22, a bent plate 23, an extension portion 26, and a contact portion 27.

The upper cap 21 may form an upper exterior of the cap assembly 20 and may be disposed in the opening 13. The upper cap 21 may be electrically connected to the first electrode plate 31 through the lower cap 22 and the bent plate 23, which will be described below.

The upper cap 21 according to the present embodiment may have a disk shape with a central portion that convexly protrudes upward. A central axis of the upper cap 21 may be coaxial the central axis C of the case 10. The central portion of the upper cap 21 may protrude outward from the case 10. An edge portion of the upper cap 21 may be disposed in the case 10. A perimeter surface of the edge portion of the upper cap 21 may be spaced a predetermined distance from the inner surface of the gasket 24. The upper cap 21 may be formed of a material, such as nickel, aluminum, or copper, through which a current may flow.

An upper cap hole 211 for discharging gas or the like generated in the case 10 to outside of the case 10 may be formed in the upper cap 21. The upper cap hole 211 according to the present embodiment may have a shape passing through a perimeter surface of the central portion of the upper cap 21. The upper cap hole 211 may be provided as a plurality of upper cap holes 211. The plurality of upper cap holes 211 may be disposed at predetermined intervals along the perimeter surface of the central portion of the upper cap 21.

The lower cap 22 may be disposed to face the upper cap 21 and be electrically connected to the electrode assembly 30.

The lower cap 22 according to the present embodiment may be a substantially a disk shape and disposed in the case 10. The lower cap 22 may be disposed under the upper cap 21. That is, the lower cap 22 may be disposed between the upper cap 21 and the electrode assembly 30. A central axis of the lower cap 22 may be coaxial with the central axis C of the case 10. An upper surface of the lower cap 22 may be spaced apart from a lower surface of the upper cap 21.

An area of the lower cap 22 may have a smaller cross-sectional area (perpendicular to the central axis C of the case 10) than a cross-sectional area of the electrode assembly 30. However, the cross-sectional area of the lower cap 22 is not limited to such a configuration and may be the same as the cross-sectional area of the electrode assembly 30 or greater than the cross-sectional area of the electrode assembly 30.

The lower cap 22 may be formed of a material, such as nickel, aluminum, or copper, though which a current may flow. The lower cap 22 may be electrically connected to the electrode assembly 30. As an example, the end portion of the first electrode tab 41 extending from the first electrode plate 31 may be connected to a lower surface of the lower cap 22 through any of various coupling methods such as welding. The lower cap 22 may be electrically connected to the upper cap 21 through the bent plate 23, which will be described below.

A lower cap hole 221 vertically passing through the lower cap 22 may be formed in the lower cap 22. The lower cap hole 221 may provide a passage through which gas or the like generated in the case 10 flows through when an overcurrent is generated in the battery. The lower cap hole 221 may be provided as a plurality of lower cap holes 221. The plurality of lower cap holes 221 may be disposed along a circumference around the central axis of the cap-down 22.

The bent plate 23 may be disposed between the upper cap 21 and the lower cap22. When the secondary battery 1 operates normally, the bent plate 23 may provide a passage to allow a current to flow between the upper cap 21 and the lower cap 22. When an overcurrent is generated, the bent plate 23 is deformed due to a pressure of gas generated in the case 10 to block electrical connection between the upper cap 21 and the lower cap 22. When an inner pressure of the case 10 increases to a set magnitude or more, the bent plate 23 may be broken to open the gas discharge passage between the upper cap hole 211 and the lower cap hole 221.

The bent plate 23 according to the present embodiment may be formed in substantially a disk shape. Both upper and lower surfaces of the bent plate 23 may be disposed to face the upper cap 21 and the lower cap 22. The lower surface of the bent plate 23 may be disposed to face the lower cap hole 221. A central axis of the bent plate 23 may be coaxial with the central axis C of the case 10. The bent plate 23 may be formed of a material, such as nickel, aluminum, or copper, through which a current may flow.

A cap insulator 25 may be disposed between the bent plate 23 and the lower cap 22. The cap insulator 25 may prevent direct contact between the bent plate 23 and the lower cap 22 and guide the bent plate 23 and the lower cap 22 to be electrically connected through only the contact portion 27, which will be described below.

The cap insulator 25 according to the present embodiment may be formed in a hollow ring shape. A central axis of the cap insulator 25 may be coaxial with the central axis C of the case 10 and the central axis of the bent plate 23. An upper surface of the cap insulator 25 may be in contact with the lower surface of the bent plate 23, and a lower surface of the cap insulator 25 may be in contact with the upper surface of the lower cap 22. The cap insulator 25 may be formed of an insulation material such as PE, PP, or PET.

The extension portion 26 may extend from the bent plate 23 and may be connected to the upper cap 21. The extension portion 26 may serve as a part which supports the bent plate 23 against the upper cap 21 and provides electrical connection between the upper cap 21 and the bent plate 23. The extension portion 26 may be formed of the same material as the bent plate 23.

The extension portion 26 according to the present embodiment may include a support part 261 and a hinge part 262.

The support part 261 may form an exterior of one side of the extension portion 26 and may be connected to the upper cap 21. The support part 261 according to the present embodiment may be disposed to surround an end portion of the upper cap 21, that is, an edge region of the upper cap 21 facing the gasket 24. As an example, a cross-sectional shape of the support part 261 may have substantially a “U” shape. One end portion of the support part 261 may be in contact with an upper surface of the upper cap 21, and the other end portion of the support part 261 may be bent downward to be in contact with the lower surface of the upper cap 21. The support part 261 may be coupled to the upper cap 21 through any of various methods such as laser welding, ultrasonic welding, and resistance welding methods.

The hinge part 262 may form an exterior of the other side of the extension portion 26 and may be disposed between the support part 261 and the bent plate 23. The hinge part 262 may connect the support part 261 and the bent plate 23 to each other and guides deformation of the bent plate 23 when an internal pressure of the case 10 increases.

The hinge part 262 according to the present embodiment may have a substantially circular ring shape and may be disposed between the support part 261 and the bent plate 23. An inner circumferential surface of the hinge part 262 may be connected to the bent plate 23, and an outer circumferential surface of the hinge part 262 may be connected to the other end portion of the support part 261. The hinge part 262 may be stepped downward from the outer circumferential surface toward the inner circumferential surface. As an example, a central portion of the hinge part 262 may have a cross section bent in an “L” shape. The angle of the central portion of the hinge part 262 may be variously changed to angles other than the angle illustrated in FIG. 2.

When an overcurrent is generated, the bent plate 23 may be deformed with respect to the hinge part 262. As an example, when an internal pressure of the case 10 increases due to an overcurrent, gas passing through the lower cap hole 221 may press the bent plate 23 upward, and the bent plate 23 may be deformed such that a central portion of the bent plate 23 convexly protrudes upward due to a change in a bent angle of the hinge part 262.

The contact portion 27 may protrude from the bent plate 23 toward the lower cap 22 and may be in contact with the lower cap 22. The contact portion 27 may electrically connect the bent plate 23 and the lower cap 22. Accordingly, a current generated from the first electrode plate 31 may be transmitted to the upper cap 21 sequentially through the first electrode tab 41, the lower cap 22, the contact portion 27, the bent plate 23, and the extension portion 26.

The contact portion 27 according to the present embodiment may protrude downward from the lower surface of the bent plate 23. A lower surface of the contact portion 27 may be in contact with the upper surface of the lower cap 22. A central axis of the contact portion 27 may be coaxial with the central axis C of the case 10 and the central axis of the bent plate 23. The diameter of the contact portion 27 may be smaller than an inner diameter of the cap insulator 25.

When the bent plate 23 is deformed due to an increase in internal pressure of the case 10, the contact portion 27 may be separated from the lower cap 22. Accordingly, when an overcurrent is generated, electrical connection between the lower cap 22 and the bent plate 23 may be blocked.

A thickness of a portion of the bent plate 23 according to the present embodiment may increase toward the central axis C of the case 10. In this case, a thickness of the bent plate 23 may be a vertical length of the bent plate 23 parallel to the central axis C of the case 10.

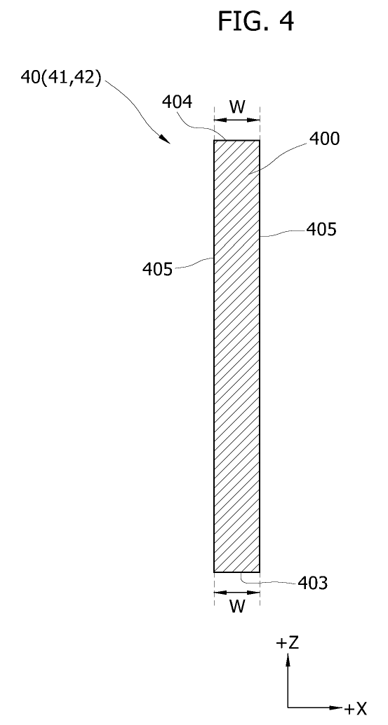

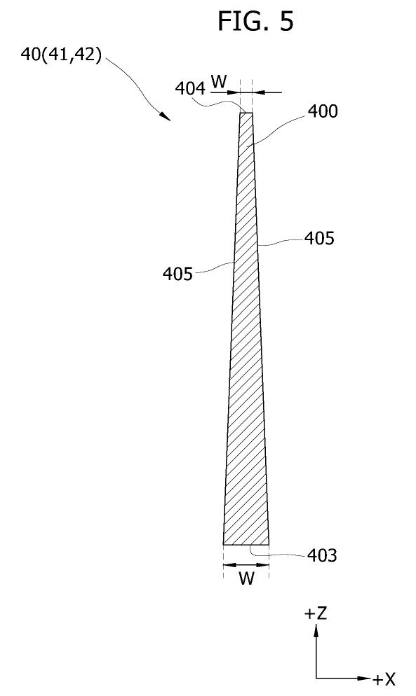

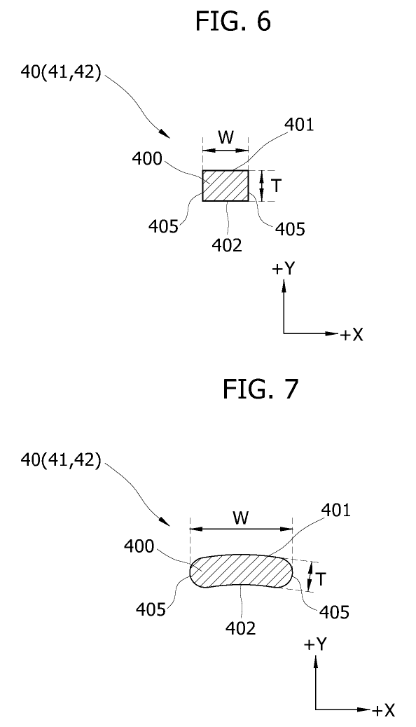

FIG. 3 is a side view of an electrode tab according to an embodiment of the present disclosure. FIG. 4 is a plan view of a first example of the electrode tab according to the present disclosure, and FIG. 5 is a plan view of a second example of the electrode tab according to the present disclosure. FIG. 6 is a top view of the first example of the electrode tab according to the present disclosure, and FIG. 7 is a top view of the second example of the electrode tab according to the present disclosure.

An electrode tab 40 illustrated in FIGS. 3 to 7 is an example of the electrode tab 40 illustrated in FIGS. 1 and 2. Accordingly, descriptions of the electrode tab 40 above will not be repeated.

A shape of the electrode tab 40 will be described with reference to FIGS. 3 to 7.

The electrode tab 40 may include a first electrode tab 41 and a second electrode tab 42. The first electrode tab 41 may be electrically connected to a first electrode plate 31. The second electrode tab 42 may be electrically connected to a second electrode plate 32. The following descriptions of the electrode tab 40 are applicable to both the first electrode tab 41 and the second electrode tab 42.

The electrode tab 40 may include an electrode tab body 400, an electrode tab contact portion 401, an inclined electrode tab portion 402, an electrode tab central portion 403, an electrode tab end portion 404, and an electrode tab side portion 405.

The electrode tab body 400 may be provided in a rod shape extending parallel to one direction (for example, a Z-axis direction). The electrode tab body 400 may be disposed to be electrically connected to the electrode assembly 30. That is, the electrode tab body 400 may be electrically connected to a first electrode plate 31 and/or a second electrode plate 32 of the electrode assembly 30.

The electrode tab contact portion 401, the inclined electrode tab portion 402, the electrode tab central portion 403, the electrode tab end portion 404, and the electrode tab side portion 405 may be disposed on the electrode tab body 400.

According to an embodiment, the electrode tab contact portion 401 may be in contact with and electrically connected to the first electrode plate 31 and/or the second electrode plate 32. According to another example, an inclined electrode tab portion 402 may be in contact with and electrically connected to a first electrode plate 31 and/or a second electrode plate 32.

Referring to FIG. 3, the inclined electrode tab portion 402 may opposite the electrode tab contact portion 401. The inclined electrode tab portion 402 may be inclined with respect to one direction (for example, the Z-axis direction).

According to an embodiment, the inclined electrode tab portion 402 may be disposed to intersect a longitudinal direction (for example, the Z-axis direction) of a case 10 of a secondary battery 1. As the inclined electrode tab portion 402 is disposed to be inclined with respect to one direction, a thickness T of the electrode tab body 400 varies along the length of the electrode tab body 400. According to an embodiment, the thickness T of the electrode tab body 400 may decrease toward a central portion of the case 10 in a height direction (for example, the Z-axis direction).

The electrode tab central portion 403 may be disposed closer to the central portion of the case 10 than the electrode tab end portion 404 in the height direction (for example, the Z-axis direction), and the electrode tab end portion 404 may be disposed further away from the central portion of the case 10 than the electrode tab central portion 403 is from the central portion of the case 10 in the height direction (for example, the Z-axis direction).

In the first electrode tab 41, the thickness T of the electrode tab body 400 may decrease toward a lower portion of (for example, in a −Z-axis direction from) the case 10. On the other hand, in the second electrode tab 42, the thickness T of the electrode tab body 400 may increase toward an upper portion of (for example, in a +Z-axis direction from) the case 10. As described above, as the thickness T of the electrode tab body 400 decreases toward the central portion of the case 10 in the height direction (for example, the Z-axis direction), a change in a thickness of the electrode assembly 30 due to the electrode tab body 400 in the central portion of the case 10 in the height direction may decrease. The thickness T of the electrode tab body 400 may range from about 0.03 mm to 0.2 mm.

Referring to FIG. 4, electrode tab side portions 405 may be disposed on sides (for example, in an X-axis direction) of the electrode tab body 400. The electrode tab side portions 405 may be parallel to each other. According to an embodiment, the electrode tab side portions 405 may extend in a direction (for example, the Z-axis direction). As described above, as the electrode tab side portions 405 are disposed parallel to each other, thus a constant width W of the electrode tab body 400 can be maintained through the length of the electrode tab body 400.

Referring to FIG. 5, in another embodiment the electrode tab side portions 405 disposed on sides of an electrode tab body 400 may extend in directions intersecting each other. According to an embodiment, the electrode tab side portions 405 may generally extend one direction (for example, a Z-axis direction). As the electrode tab side portions 405 extend toward each other, a width W of the electrode tab body 400 may decrease.

According to an embodiment, a width W of an electrode tab end portion 404 may be less than a width W of an electrode tab central portion 403. According to another example, a width W of an electrode tab end portion 404 may be greater than a width W of an electrode tab central portion 403.

As described above, as the width W is varied, there is flexibility in the design of the electrode tab 40 disposed in the electrode assembly 30. In some embodiments, the width W of the electrode tab body 400 may range from about 1.0 mm to 10.0 mm.

Both of the examples of the electrode tab 40 illustrated in FIGS. 4 and 5 may be applied. According to one embodiment, the width W of the electrode tab end portion 404 may be less than the width W of the electrode tab central portion 403, and a thickness T of the electrode tab end portion 404 may be greater than a thickness T of the electrode tab central portion 403.

A cross section of an electrode tab 40 which is perpendicular to a longitudinal direction of the electrode tab 40 is shown in FIGS. 6 and 7.

Referring to FIG. 6, a cross-sectional shape of the electrode tab 40 may be provided as a substantially quadrangular shape. According to one embodiment, the cross-sectional shape of the electrode tab 40 may be provided as a substantially rectangular shape. But the cross-sectional shape of the electrode tab 40 is not limited to the quadrangular shape and may be any of various shapes.

Referring to FIG. 7, a cross-sectional shape of the electrode tab 40 may be provided as a closed curve shape. According to one embodiment, the cross-sectional shape of the electrode tab 40 may be provided as substantially an arc shape. As the cross-sectional shape of the electrode tab 40 is provided as substantially the arc shape, there may be less increase in a thickness of an electrode assembly 30 due to an electrode tab 40 disposed in the electrode assembly 30. In addition, as the shape of the electrode tab 40 is provided as substantially the arc shape, a contact area between the electrode assembly 30 and the electrode tab 40 may increase, and a cross-sectional shape of the electrode assembly 30 may be formed to be close to a circular shape. Further, there may a reduced possibility of a short occurring in the electrode assembly 30.

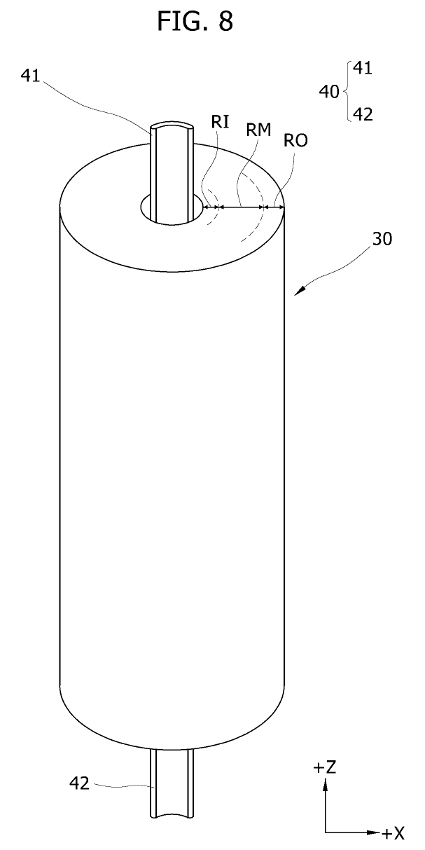

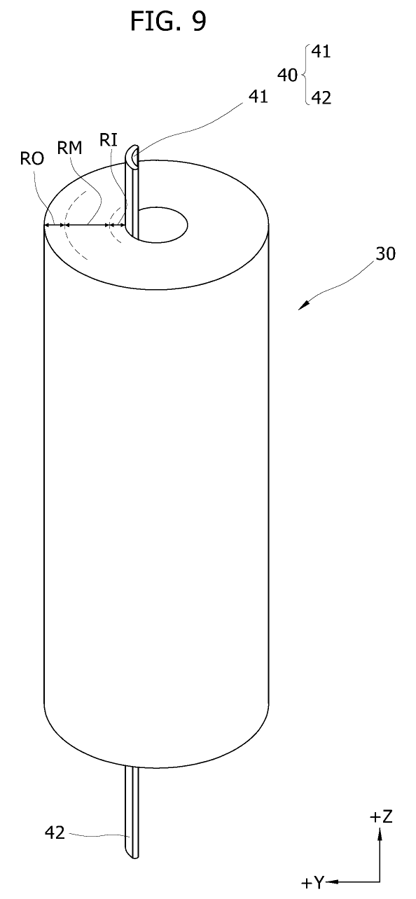

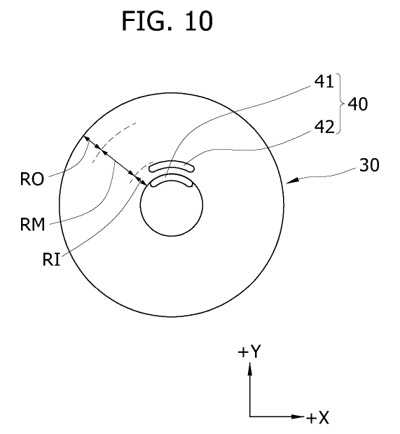

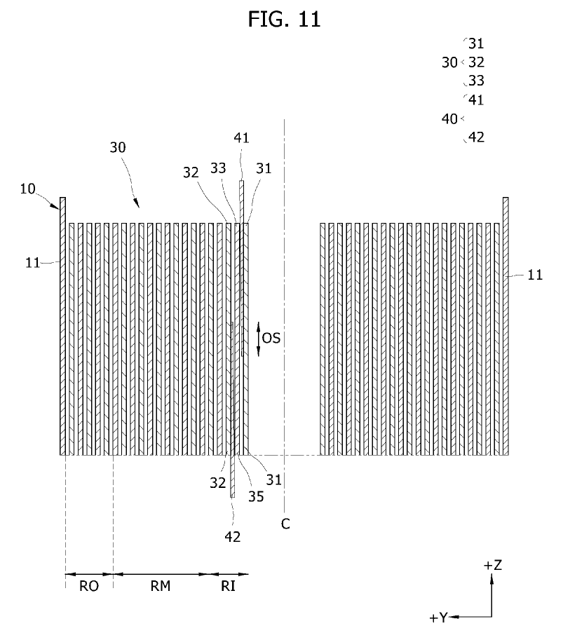

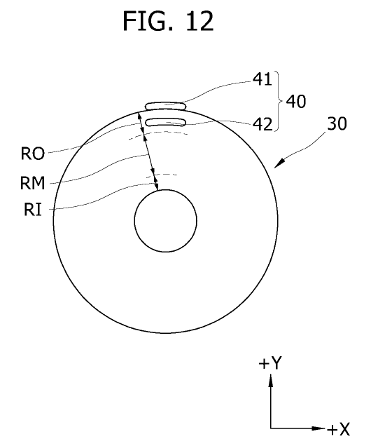

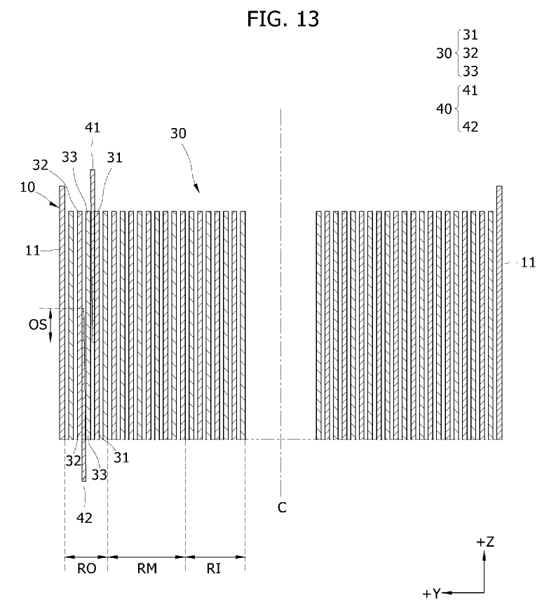

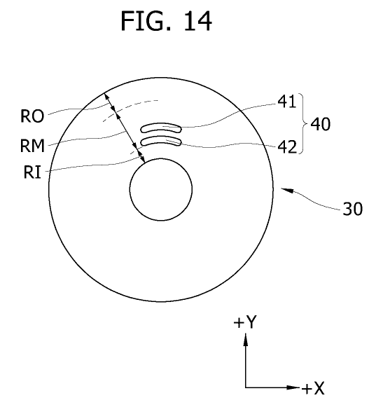

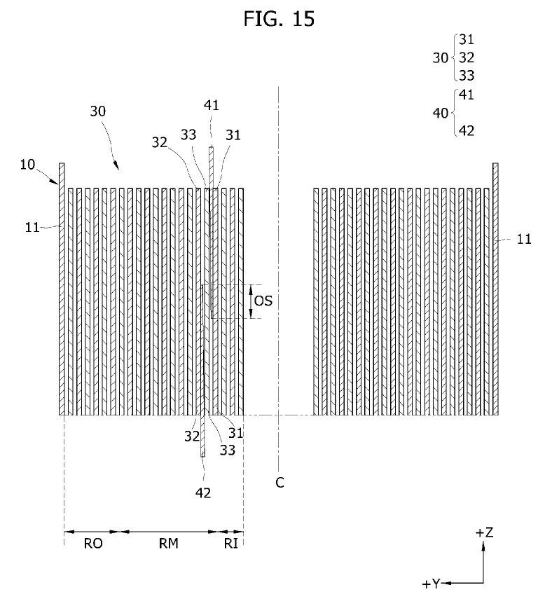

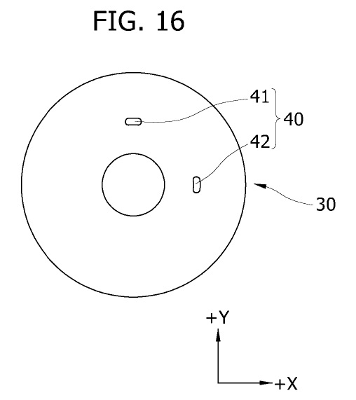

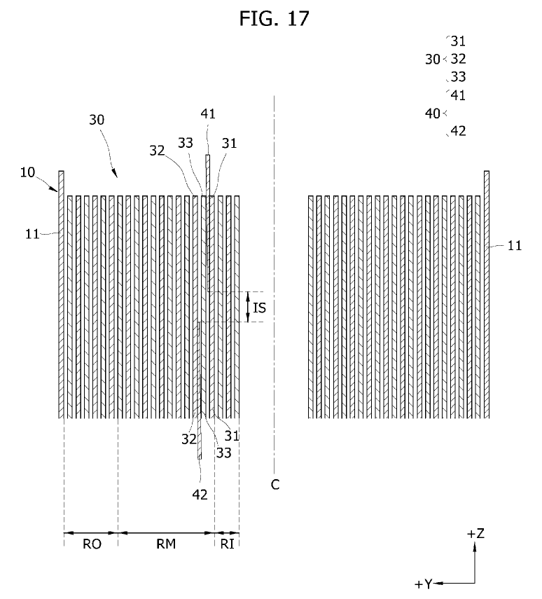

FIG. 8 is a front perspective view of a first example in which an electrode tab is disposed in a secondary battery according to the present disclosure, and FIG. 9 is a side perspective view of the first example in which the electrode tab is disposed in the secondary battery according to the present invention. FIG. 10 is a plan view of the first example in which the electrode tab is disposed in the secondary battery according to the present disclosure, and FIG. 11 is a cross-sectional view illustrating the first example in which the electrode tab is disposed in the secondary battery according to the present disclosure. FIG. 12 is a plan view of a second example in which an electrode tab is disposed in a secondary battery according to the present disclosure, FIG. 13 is a cross-sectional view of the second example in which the electrode tab is disposed in the secondary battery according to the present disclosure, FIG. 14 is a plan view of a third example in which an electrode tab is disposed in a secondary battery according to the present disclosure, and FIG. 15 is a cross-sectional view of the third example in which the electrode tab is disposed in the secondary battery according to the present disclosure. FIG. 16 is a plan view of a fourth example in which an electrode tab is disposed in a secondary battery according to the present disclosure, and FIG. 17 is a cross-sectional view of a fifth example in which an electrode tab is disposed in a secondary battery according to the present disclosure.

Aspects of an electrode assembly 30 and an electrode tab 40 illustrated in FIGS. 8 to 17 are the same as the electrode assembly 30 and the electrode tab 40 illustrated in FIGS. 1 to 7. Accordingly, descriptions of the same aspects will be omitted.

The electrode assembly 30 may include a radial center portion RI, a radial middle portion RM, and a radial outer portion RO according to a length from a central axis C in a radial direction. The radial center portion RI, the radial middle portion RM, and the radial outer portion RO may be sequentially disposed from the central axis C.

The radial center portion RI, the radial middle portion RM, and the radial outer portion RO may be defined along the length of the electrode assembly 30 in the radial direction. The radial center portion RI may be a section corresponding to about 20% to 30% of the length of the electrode assembly 30 in the radial direction from the central axis C. The radial middle portion RM may be a section corresponding to about 30% to 40% of the length of the electrode assembly 30 in the radial direction from the radial center portion RI. The radial outer portion RO may be a section corresponding to about 30% to 50% of the length of the electrode assembly 30 in the radial direction from the radial middle portion RM.

The electrode tab 40 may be disposed in the radial center portion RI, the radial middle portion RM, and/or the radial outer portion RO of the electrode assembly 30. According to one embodiment, a first electrode tab 41 and a second electrode tab 42 may be disposed in the radial center portion RI. According to another embodiment, the first electrode tab 41 may be disposed in the radial middle portion RM, and the second electrode tab 42 may be disposed in the radial outer portion RO. That is, the first electrode tab 41 and the second electrode tab 42 may be disposed in the same section (the radial center portion RI, the radial middle portion RM, or the radial outer portion RO) or in different sections (the radial center portion RI, the radial middle portion RM, and the radial outer portion RO).

According to an embodiment, the electrode tab 40 may be disposed on an inner circumferential surface and/or an outer circumferential surface of the electrode assembly 30 and/or between the inner circumferential surface and the outer circumferential surface.

An example in which the first electrode tab 41 and the second electrode tab 42 are disposed in the radial center portion RI is illustrated in FIGS. 8 to 11, an example in which the first electrode tab 41 and the second electrode tab 42 are disposed in the radial middle portion RM is illustrated in FIGS. 12 and 13, and an example in which the first electrode tab 41 and the second electrode tab 42 are disposed in the radial outer portion RO is illustrated in FIGS. 14 and 15.

The first electrode tab 41 may be electrically connected to a first electrode plate 31, and the second electrode tab 42 may be electrically connected to a second electrode plate 32. The first electrode tab 41 and the second electrode tab 42 may be disposed to overlap at one point in a longitudinal direction (for example, a Z-axis direction) of the electrode assembly 30. A section in which the first electrode tab 41 and the second electrode tab 42 overlap may be defined as an overlapping section OS. As there is an overlapping section OS in the first electrode tab 41 and the second electrode tab 42, a volume of the electrode assembly 30 may increase in the radial direction (for example, a Y-axis direction) due to thicknesses T of the the overlapping tabs 41 and 43.

As illustrated in FIG. 3 and described above, a thickness T of each of the first electrode tab 41 and the second electrode tab 42 may change in the longitudinal direction (for example, the Z-axis direction). According to one embodiment, the thickness T of the first electrode tab 41 may decrease toward a lower side (for example, in a −Z-axis direction) of the electrode assembly 30, and the thickness T of the second electrode tab 42 may decrease toward an upper side (for example, in a +Z-axis direction) of the electrode assembly 30. Since the thickness T of each of the first electrode tab 41 and the second electrode tab 42 decreases toward a central portion of the electrode assembly 30 in the longitudinal direction, a a thickness of the electrode assembly 30 due to the overlapping electrode tabs 41 and 42 may be reduced. And as there is less of an increase in the thickness of the electrode assembly 30 due to the electrode tabs 41 and 42, stability of the electrode assembly 30 can be improved.

As illustrated in FIG. 5, a width W of each of the first electrode tab 41 and the second electrode tab 42 may change in the longitudinal direction (for example, the Z-axis direction). According to one embodiment, the width W of the first electrode tab 41 may increase toward the lower side (for example, in the −Z-axis direction) of the electrode assembly 30, and the width W of the second electrode tab 42 may increase toward the upper side (for example, in the +Z-axis direction) of the electrode assembly 30. As the width W of each of the first electrode tab 41 and the second electrode tab 42 increases toward the central portion (for example, a vertically central portion) of the electrode assembly 30 in a height direction, a resistance of each of the first electrode tab 41 and the second electrode tab 42 may decrease. With such a configuration, an increase in resistance of the electrode tab 40 due to the decrease in thickness T of the electrode tab 40 can be suppressed.

A cross-section of the electrode tab 40 in a direction perpendicular to the longitudinal direction (for example, the Z-axis direction) may vary as illustrated in FIGS. 6 and 7.

The electrode tab 40 may be in close contact with the electrode assembly 30 through a cross-sectional shape of the electrode tab 40 illustrated in FIG. 7. A curvature of a cross-sectional shape of the electrode tab 40 disposed in the radial outer portion RO is less than a curvature of a cross-sectional shape of the electrode tab 40 disposed in the radial middle portion RM. The curvature of the cross-sectional shape of the electrode tab 40 disposed in the radial middle portion RM is less than a curvature of a cross-sectional shape of the electrode tab 40 disposed in the radial center portion RI.

As described above, the cross-sectional shape and the curvature of the cross-sectional shape of the electrode tab 40 may change according to the section in which the electrode tab 40 is disposed in the radial direction of the electrode assembly 30. As the curvature of the electrode tab 40 changes, the electrode tab 40 and the electrode assembly 30 may be disposed in close contact with each other. Accordingly, the probability of cracks occurring in the electrode assembly 30 and/or the electrode tab 40 is decreased and stability of the structures is improved.

Referring to FIGS. 8 to 15, when the electrode assembly 30 is viewed from above, the first electrode tab 41 and the second electrode tab 42 may overlap in one radial direction of the electrode assembly 30.

Referring to FIG. 16, when the electrode assembly 30 is viewed from above, the first electrode tab 41 and the second electrode tab 42 may be disposed not to overlap in the radial direction of the electrode assembly 30. As the first electrode tab 41 and the second electrode tab 42 do not to overlap, there is less of an increase in the thickness of the electrode assembly 30 in the radial direction due to a thickness T of the electrode tab 40. Accordingly, there is less of a possibility of cracks occurring in the electrode assembly 30 and the electrode tab 40.

Referring to FIG. 17, the first electrode tab 41 and the second electrode tab 42 may be spaced apart from each other in the longitudinal direction (for example, the Z-axis direction) of the electrode assembly 30. A section in which the first electrode tab 41 is spaced apart from the second electrode tab 42 may be defined as a spaced section IS. As the first electrode tab 41 is spaced apart from the second electrode tab 42 so that there is a spaced section IS, the electrode tabs 41 and 42 do not overlap, and there is less of an increase in volume of the electrode assembly 30 in the radial direction.

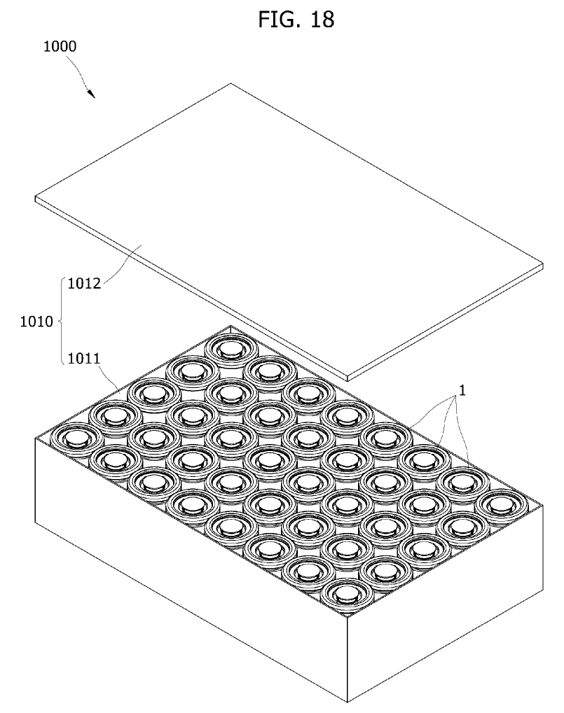

FIG. 18 is an exploded perspective view illustrating a battery pack according to an embodiment of the present disclosure.

Referring to FIG. 18, a battery pack 1000 according to various embodiments includes a housing 1010 and a secondary battery 1.

The housing 1010 may form an exterior of the battery pack 1000 and provide a space in which the secondary battery 1 is accommodated. The housing 1010 according to the present embodiment may include a housing body 1011 and a housing cover 1012.

The housing body 1011 may be formed as a hollow box with one open side. A cross-sectional shape of the housing body 1011 is not limited to a quadrangular shape illustrated in FIG. 18, and the cross-sectional shape may be , for example, a polygonal shape, a circular shape, and an elliptical shape.

The housing cover 1012 may be coupled to the housing body 1011 and may close an inner space of the housing body 1011. As an example, the housing cover 1012 may be formed as a plate shape and disposed to face the open side of the housing body 1011. The housing cover 1012 may be fixed to the housing body 1011 through any of various methods such as bolting, welding, and fit-coupling methods.

The secondary batteries 1 may serve as a unit structure for storing and supplying power in the battery pack 1000. The secondary batteries 1 illustrated in FIG. 18 includes the secondary battery 1 illustrated in FIGS. 1 to 17.

The secondary battery 1 may be provided as a plurality of secondary batteries 1. The secondary batteries 1 may be disposed in various patterns such as a lattice pattern and a zigzag pattern in the housing 1010. The secondary batteries 1 may be disposed parallel to each other. The number of secondary batteries 1 may be variously changed according to a size, a shape, and the like of the housing 1010.

The plurality of secondary batteries 1 may be electrically connected to each other through a busbar (not shown). The plurality of secondary batteries 1 may be connected in series or parallel through the busbar. As an example, the busbar may connect the secondary batteries 1 disposed in the same row in the housing 1010 in parallel and connect the secondary batteries 1 disposed in two adjacent rows in series. The busbar may be formed of a material such as copper, aluminum, or nickel, through which a current may flow.

Deformation of an electrode assembly can be minimized using a secondary battery and a battery pack including the secondary battery according to embodiments of the present disclosure.

In addition, durability and safety can be improved using a secondary battery and a battery pack including the secondary battery according to the present disclosure.

The effects obtainable through the present disclosure are not limited to those described herein, and other technical effects that are not mentioned will be clearly understood by those skilled in the art from the present disclosure.

While the present disclosure has been described with reference to embodiments shown in the drawings, these embodiments are merely illustrative and various modifications and equivalent other embodiments can be derived by those skilled in the art.

What is claimed is:

1. A secondary battery comprising:
a case having an opening formed therein;
an electrode assembly accommodated in the case;
a cap assembly closing the opening; and
an electrode tab that is electrically connected to the electrode assembly and the cap assembly, with a thickness of the electrode tab decreasing from an end portion of the electrode tab toward a central portion of the electrode assembly in a height direction of the electrode assembly.

2. The secondary battery as claimed in claim 1, wherein the cap assembly includes:
a upper cap disposed at the opening;
a lower cap disposed to face the upper cap and connected to the electrode assembly; and
a bent plate disposed between the upper cap and the lower cap.

3. The secondary battery as claimed in claim 1, wherein a cross section of the electrode tab that is perpendicular to a longitudinal direction of the electrode tab is a quadrangular shape.

4. The secondary battery as claimed in claim 1, wherein a cross section of the electrode tab that is perpendicular to a longitudinal direction of the electrode tab is a closed curved shape.

5. The secondary battery as claimed in claim 1, wherein a width of the electrode tab is constant from the end portion toward the central portion of the electrode assembly in the height direction of the electrode assembly.

6. The secondary battery as claimed in claim 1, wherein a width of the electrode tab increases from the end portion toward the central portion of the electrode assembly in the height direction of the electrode assembly.

7. The secondary battery as claimed in claim 1, wherein the electrode tab is positioned at a center portion of the electrode assembly in a radial direction of the electrode assembly.

8. The secondary battery as claimed in claim 1, wherein the electrode tab is positioned at an outer portion of the electrode assembly in a radial direction of the electrode assembly.

9. The secondary battery as claimed in claim 1, wherein the electrode tab is positioned between a center portion and an outer portion of the electrode assembly in a radial direction of the electrode assembly.

10. The secondary battery as claimed in claim 1, wherein the electrode tab includes:
a first electrode tab electrically connected to the cap assembly; and
a second electrode tab electrically connected to the case.

11. The secondary battery as claimed in claim 10, wherein the first electrode tab and the second electrode tab are spaced apart from each other in a radial direction of the electrode assembly.

12. The secondary battery as claimed in claim 10, wherein the first electrode tab and the second electrode tab are overlap in a radial direction of the electrode assembly.

13. The secondary battery as claimed in claim 11, wherein the first electrode tab and the second electrode tab are spaced apart from each other in the height direction of the electrode assembly.

14. The secondary battery as claimed in claim 11, wherein the first electrode tab and the second electrode tab overlap in the height direction of the electrode assembly.

15. A battery pack comprising:
a housing; and
a plurality of secondary batteries disposed in the housing,
wherein each of the secondary batteries includes a case having an opening formed therein, an electrode assembly accommodated in the case, a cap assembly closing the opening, and an electrode tab that is electrically connected to the electrode assembly and the cap assembly, with a thickness of the electrode tab decreasing from an end portion of the electrode tab toward a central portion of the electrode assembly in a height direction of the electrode assembly.

16. The battery pack as claimed in claim 15, wherein a cross section of the electrode tab that is perpendicular to a longitudinal direction of the electrode tab is a quadrangular shape.

17. The battery pack as claimed in claim 15, wherein a a cross section of the electrode tab that is perpendicular to a longitudinal direction of the electrode tab is a closed curved shape.

18. The battery pack as claimed in claim 15, wherein a width of the electrode tab is constant from the end portion toward the central portion of the electrode assembly in the height direction of the electrode assembly.
